(19) United States
(12) Patent Application Publication
(10) Pub. No.: US 2026/0217322 A1
(43) Pub. Date: Jul. 30, 2026

(54) TRACTOR

(71) Applicants: INTRADIN (SHANGHAI) INTELLIGENT MACHINERY CO., LTD., Shanghai (CN); GREAT CIRCLE MACHINERY CORP, ONTARIO, CA (US)

(72) Inventors: Wei ZHOU, Shanghai (CN); Junliang WANG, Shanghai (CN)

(21) Appl. No.: 19/578,229

(22) Filed: Mar. 25, 2026

(30) Foreign Application Priority Data
Jan. 9, 2026 (CN) 202620025728.8

(51) Int. Cl. B62D 51/04

(52) U.S. Cl. CPC B62D 51/04

(57) ABSTRACT

A tractor includes a frame, a rear axle assembly and a wheel assembly. The rear axle assembly is arranged on an end of the frame. The wheel assembly includes a support rod and a wheel. A first end of the support rod is connected with the rear axle assembly, and a second end of the support rod is connected with the wheel. The support rod is configured to inclinedly extend from an end of the rear axle assembly towards an outer side of the frame.

### CROSS-REFERENCE TO RELATED APPLICATIONS

This application claims the benefit of priority from Chinese Patent Application No. 202620025728.8, filed on January 9, 2026. The content of the aforementioned application, including any intervening amendments thereto, is incorporated herein by reference in its entirety.

### TECHNICAL FIELD

This application relates to transportation tools, and more particularly to a tractor.

### BACKGROUND

An electric tractor is mainly composed of a handlebar, a control system, a power wheel, a universal wheel, a ball joint assembly, a rear axle assembly, and an auxiliary wheel assembly. Under normal conditions, the auxiliary wheel assembly maintains a certain distance from the ground, providing support to ensure towing safety when tipping occurs during towing process. In existing designs, two square tubes are parallelly welded onto a frame, where an extension direction of each square tube is parallel to a travel direction of the electric tractor, then a support rod of the auxiliary wheel assembly is inserted into each square tube and is fixed with a pin. The support rod of the auxiliary wheel assembly has a straight-rod structure. When the electric tractor tows a travel trailer, such straight-rod structure tends to interfere with a front-mounted jack of the travel trailer and limits its rotation range.

### S UMMARY

In view of the above problems, it is necessary to provide a tractor to solve the above problems.

A tractor is provided, comprising:

a frame;

a rear axle assembly; and

a wheel assembly;

wherein the rear axle assembly is arranged on a first end of the frame; the wheel assembly comprises a support rod and a first wheel; a first end of the support rod is connected with the rear axle assembly, and a second end of the support rod is connected with the first wheel; and the support rod is configured to inclinedly extend from the first of the support rod towards an outer side of the frame.

In an embodiment, the support rod comprises a first support section, a second support section and a third support section connected in sequence; the first support section is connected with the rear axle assembly; an extension direction of the first support section is parallel to a travel direction of the tractor; the second support section is arc-shaped; the third support section is configured to inclinedly extend from an end of the second support section away from the first support section towards the outer side of the frame; and the third support section is connected with the first wheel.

In an embodiment, the rear axle assembly comprises a rear axle housing; the tractor further comprises a mounting component; the mounting component is fixedly provided on the rear axle housing; the frame is connected with the mounting component; and the first end of the support rod is connected with the mounting component.

In an embodiment, the mounting component comprises two mounting plates; the two mounting plates are oppositely arranged on upper and lower sides of the rear axle housing, respectively; one of the two mounting plates is connected with the frame, and the other of the two mounting plates is connected with the support rod.

In an embodiment, the tractor further comprises a front axle assembly; the front axle assembly comprises a connecting rod and a swing axle; the connecting rod is arranged on a second end of the frame; the swing axle is inserted through the connecting rod, and is rotatably connected with the connecting rod; and the swing axle is configured to swing up and down within the connecting rod.

In an embodiment, the tractor further comprises two second wheels; and the two second wheels are arranged on two ends of the swing axle, respectively.

In an embodiment, the tractor further comprises two third wheels; the two third wheels are arranged on two ends of the rear axle assembly, respectively; and the two third wheels are rotatably connected with the rear axle assembly.

In an embodiment, the tractor further comprises a driving component; the driving component is arranged on the rear axle assembly; the driving component is connected with the two third wheels; and the driving component is configured to drive the two third wheels to rotate relative to the frame, so as to drive the tractor to move.

In an embodiment, the tractor further comprises a controller; the controller is arranged on the frame; and the controller is electrically connected with the driving component, and is configured to control the driving component to start or stop.

In an embodiment, the tractor further comprises a ball joint assembly; the ball joint assembly is arranged on the frame; and the ball joint assembly is configured to connect with a cargo carrier.

The present disclosure has the following beneficial effects.

The tractor is provided in the present disclosure. Compared to a straight-rod structure in the prior art, the present disclosure increases a motion range of a jack connected to the tractor during turning by arranging the support rod of the wheel assembly to extend from its end that connected with the rear axle assembly towards the outer side of the frame, which reduces interference on the jack, and improves operational convenience.

### BRIEF DESCRIPTION OF THE DRAWINGS

In order to illustrate the technical solutions of this application or the prior art more clearly, the accompanying drawings required in the description of embodiments or the prior art will be briefly introduced below. It is obvious that the following accompanying drawings only show some embodiments of this application, and for those of ordinary skill in the art, other relevant accompanying drawings can also be obtained according to these drawings without making creative effort.

FIG. 1 is a structural diagram of a tractor according to an embodiment of the present disclosure.

FIG. 2 is a structural diagram of the tractor, a rear axle assembly and a wheel assembly according to an embodiment of the present disclosure.

FIG. 3 is a structural diagram of the rear axle assembly according to an embodiment of the present disclosure.

FIG. 4 is a structural diagram of the tractor from another perspective according to an embodiment of the present disclosure.

FIG. 5 is a structural diagram of the tractor according to another embodiment of the present disclosure.

In figures: 1, frame; 11, crossbeam; 12, longitudinal beam; 13, ball joint assembly; 2, rear axle assembly; 21, rear axle housing; 22, mounting component; 23, mounting plate; 24, connecting tube; 3, wheel assembly; 31, support rod; 311, first support section; 312, second support section; 313, third support section; 32, first wheel; 4, front axle assembly; 41, connecting rod; 42, swing axle; 43, pin; 5, second wheel; 6, third wheel; 7, controller; and 8, handle.

The realization, functional features and advantages of the present disclosure will be further described with reference to the accompanying drawings.

### D ETAILED DESCRIPTION OF EMBODIMENTS

The technical solutions of the embodiments of the present disclosure will be clearly and completely described with reference to the accompanying drawings of the embodiments of the present disclosure. It is obvious that described herein are only some embodiments of the present disclosure, rather than all embodiments. Based on the embodiments of the present disclosure, other embodiments obtained by those of ordinary skill in the art without making creative effort shall fall within the scope of the present disclosure.

It should be noted that the terms, such as “up”, “down”, “left”, “right”, “front”, “rear” and other directional indications used herein, are only used for illustrating relative position relationship and motion between components in a specific state (as shown in the accompanying drawings). If the specific state changes, the directional indication accordingly changes.

In addition, the terms “first” and “second” are only used for distinguishment rather than indicating or implying the relative importance or implicitly specifying the number of technical features indicated. Therefore, a feature defined with “first” or “second” may explicitly or implicitly indicates the inclusion of at least one of such features. Besides, the term “and/or” used herein includes three solutions, for example, “A” and/or “B” includes solution “A”, solution “B”, and a combination thereof. Technical solutions of embodiments can be combined with each other as long as the combined solution can be implemented by those skilled in the art. When a combination of the technical solutions is contradictory or cannot be realized, it should be considered that such a combination does not exist, and is not within the scope of the present disclosure.

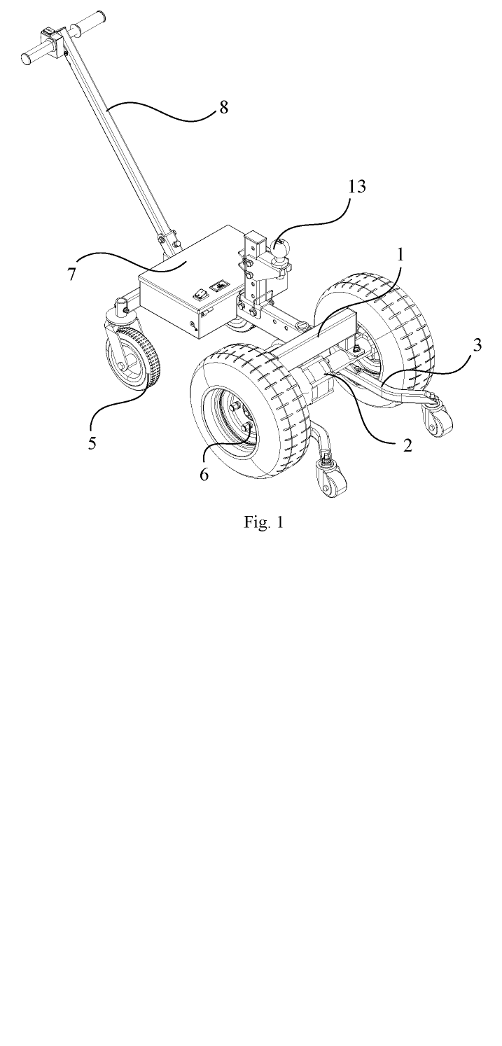

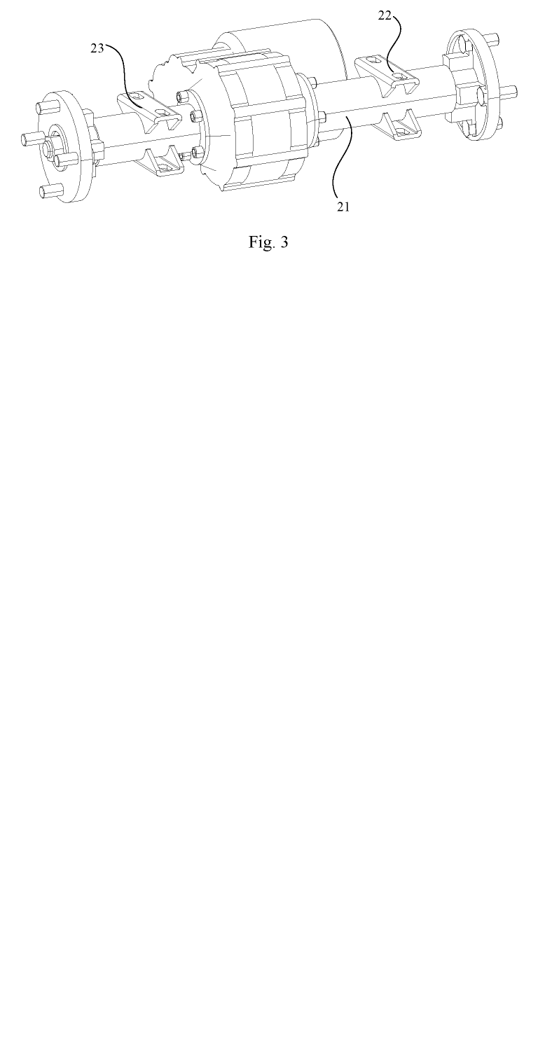

Referring to FIGS. 1-3, the present disclosure provides a tractor. The tractor includes a frame 1, a rear axle assembly 2 and a wheel assembly 3. The rear axle assembly 2 is arranged on a rear end of the frame 1. The rear axle assembly 2 includes a rear axle housing 21. The tractor further includes a mounting component 22. The mounting component 22 is fixedly provided on the rear axle housing 21, and is circumferentially provided along the rear axle housing 21. The mounting component 22 and the rear axle housing 21 are integrally formed. The frame 1 is connected with the mounting component 22. The wheel assembly 3 includes a support rod 31 and a first wheel 32. A first end of the support rod 31 is connected with the mounting component 22, and a second end of the support rod 31 is connected with the first wheel 32. The first wheel 32 is configured to rotate relative to the support rod 31.

In the prior art, two square tubes are parallelly welded onto the frame1, then the support rod 31 is inserted into the two square tubes, followed by fixation with a pin. Compared to the prior art, the tractor provided in the present disclosure, by connecting the frame 1 with a first end of the mounting component 22 and connecting the support rod 31 with a second end of the mounting component 22, reduces materials used for welding square tubes, saves welding hours, and doesn’t affect convenience of mounting the rear axle assembly 2.

In an embodiment, the mounting component 22 is fixed on the frame 1 through two bolts, and the support rod 31 is fixed on the mounting component 22 through another two bolts.

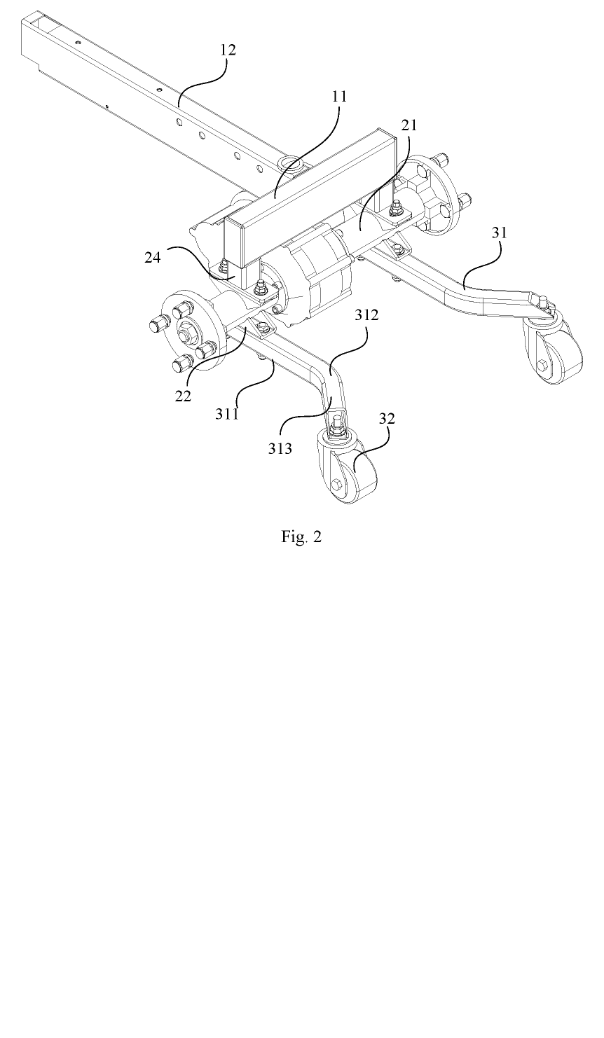

Referring to FIGS. 1-2, the support rod 31 is configured to inclinedly extend from the first end of the support rod 31 towards an outer side of the frame 1. The support rod 31 includes a first support section 311, a second support section 312 and a third support section 313 connected in sequence. The first support section 311 is connected with the mounting component 22. An extension direction of the first support section 311 is parallel to a travel direction of the tractor. The second support section 312 is arc-shaped. The third support section 313 is configured to inclinedly extend from an end of the second support section 312 away from the first support section 311 towards the outer side of the frame 1. The third support section 313 is connected with the first wheel 32.

In this embodiment, the mounting component 22, the first wheel 32 and the support rod 31 are provided in two, respectively. Two mounting components 22 are spaced apart on the rear axle housing 21. Two support rods 31 are arranged on the two mounting components 22, respectively. Two first wheels 32 are arranged on the two support rods 31, respectively.

In an embodiment, the support rod 31 has an inclined rod structure, and is configured to inclinedly extend towards the outer side of the frame 1.

In an embodiment, the frame 1 includes a crossbeam 11 and a longitudinal beam 12. The longitudinal beam 12 is arranged along an extension direction of the tractor. The crossbeam 11 is perpendicularly arranged on a rear end of the longitudinal beam 12, and the crossbeam 11 and the longitudinal beam 12 form a T-shaped structure. In an embodiment, two ends of the crossbeam 11 are connected with the two mounting components 22, respectively.

In the prior art, the support rod 31 of the wheel assembly 3 has a straight-rod structure. When the tractor is connected with a front-mounted jack of a travel trailer, the straight-rod structure tends to interfere with the front-mounted jack during sharp turns. In the present disclosure, the support rod 31 includes the first support section 311, the second support section 312 and the third support section 313, so that the support rod 31 has an outward-expanding structure. The outward-expanding structure greatly increases a motion range of the front-mounted jack during turning, making operation more convenient.

In an embodiment, the mounting component 22 includes two mounting plates 23. The two mounting plates 23 are oppositely arranged on upper and lower sides of the rear axle housing 21, respectively. The frame 1 further includes a connecting tube 24. The two mounting plates 23 includes a first mounting plate and a second mounting plate, and the first mounting plate is arranged above the second mounting plate. The connecting tube 24 is arranged between the crossbeam 11 and the first mounting plate. The first mounting plate is fixedly connected with the frame 1 through the connecting tube 24.

In this embodiment, the second mounting plate is fixedly connected with support rod 31. By arranging the support rod 31 on the second mounting plate of the rear axle assembly 2, compared with being arranged on the frame in the prior art, the present disclosure lowers a mounting height of the wheel assembly 3, and further reduces interference of the wheel assembly 3 with the front-mounted jack.

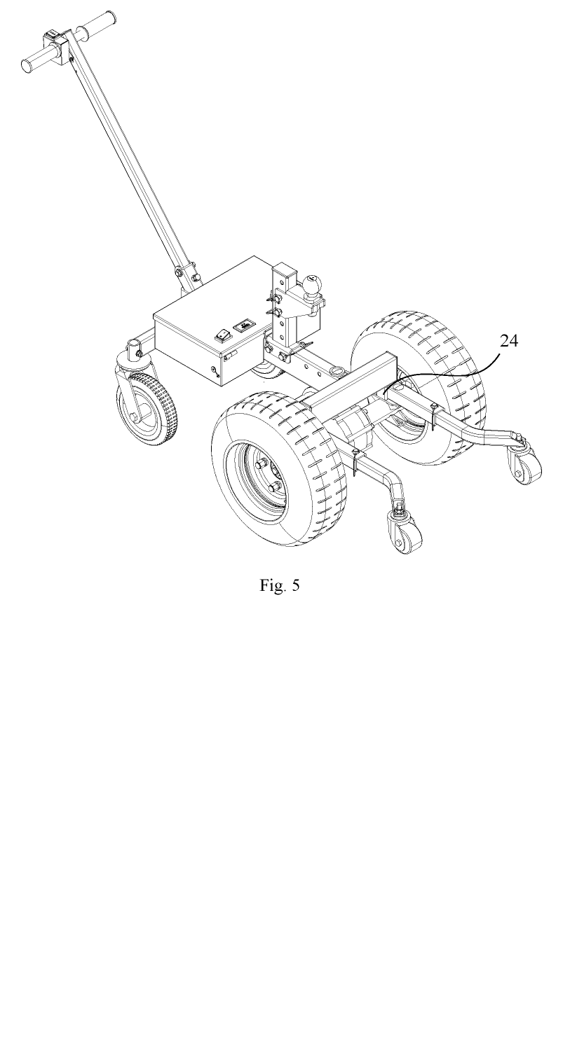

In an embodiment, referring to FIG. 5, an end of the support rod 31 away from the first wheel 32 is connected with the connecting tube 24. In an embodiment, the connecting tube 24 is connected with a sleeve. An extension direction of the sleeve is parallel to the travel direction of the tractor. The support rod 31 is inserted into the sleeve, and is detachably connected with the sleeve through a bolt. The first end of the support rod 31 is connected with the rear axle assembly 2 through the connecting tube 24 and the mounting component 22.

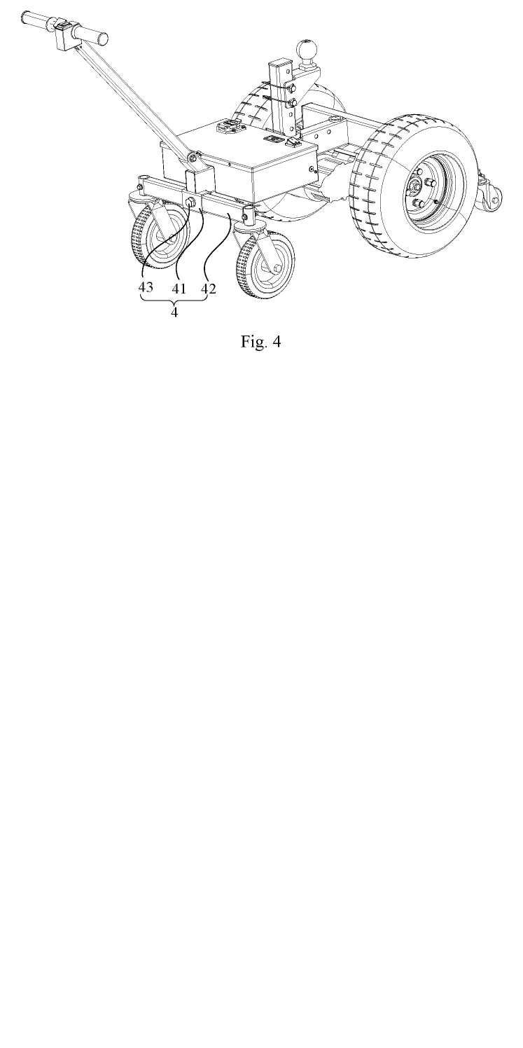

Referring to FIGS. 1-4, the tractor further includes a front axle assembly 4. The front axle assembly 4 includes a connecting rod 41, a swing axle 42 and a pin 43. The connecting rod 41 is arranged on a front end of the longitudinal beam 12. The swing axle 42 is inserted through the connecting rod 41, and is rotatably connected with the connecting rod 41 through the pin 43. The swing axle 42 is configured to swing up and down around the pin 43 within the connecting rod 41.

Referring to FIG. 1, the tractor further includes two second wheels 5. The two second wheels 5 are arranged on two ends of the swing axle 42, respectively. In an embodiment, the two second wheels 5 are universal wheels, and are configured to rotate relative to the swing axle 42.

Referring to FIG. 1, the tractor further includes two third wheels 6. The two third wheels 6 are arranged on two ends of the rear axle housing 21, respectively. The two third wheels 6 are rotatably connected with the rear axle housing 21. The first support section 311, the second support section 312 and the third support section 313 are located on an inner side of the two third wheels 6. The third support section 313 and the first wheel 32 are located behind the two third wheels 6.

In an embodiment, the two third wheels 6 and the rear axle housing 21 are coaxially arranged. A length of the first support section 311 is less than a radius of each third wheel 6.

Referring to FIG. 1, the tractor further includes a driving component. The driving component is arranged on the rear axle housing 21. The driving component is connected with the two third wheels 6. and is configured to drive the two third wheels 6 to rotate relative to the frame 1, so as to drive the tractor to move.

Referring to FIG. 1, the tractor further includes a controller 7. The controller 7 is arranged on the frame 1. The controller 7 is electrically connected with the driving component, and is configured to control the driving component to start or stop.

In an embodiment, the controller 7 is arranged on the longitudinal beam 12, and is arranged away from the crossbeam 11.

In an embodiment, the controller 7 is also configured to adjust a rotation direction of the two third wheels 6 through the driving component. The controller 7 is configured to control the two third wheels 6 to rotate forward or reverse through the driving component, so as to drive the frame 1 to move forward or backward.

Referring to FIG. 1, the tractor further includes a handle 8. The handle 8 is connected with the longitudinal beam 12, and is configured for an operator to hold. In an embodiment, the handle 8 is inclined relative to the frame 1. In practical use, the operator holds the handle 8 to prevent a movement direction of the frame 1 from deviating. When it is necessary to adjust the movement direction of the frame 1, a force can be directly applied to the handle 8 toward a desired direction, so that the movement direction of the frame 1 turns accordingly.

Referring to FIG. 1, the tractor further includes a ball joint assembly 13. The ball joint assembly 13 is arranged on the frame 1, and is configured to connect with a cargo carrier. In an embodiment, the cargo carrier is provided with a ball socket, the ball socket is configured to clamp with the ball joint assembly 13, so as to realize connection between the cargo carrier and the tractor, enabling the cargo carrier and the tractor to move synchronously and realizing transfer of goods.

In an embodiment, the ball joint assembly 13 is arranged on the longitudinal beam 12, and is spaced apart from the controller 7.

Described above are only preferred embodiments of the present disclosure, which are not intended to limit the disclosure. Under the sprits of this application, any equivalent replacements or direct/indirect application in other arts by utilizing the specification and accompanying drawings of this application shall fall within the scope of this application defined by the appended claims.

What is claimed is:

1. A tractor, comprising:
a frame;
a rear axle assembly; and
a wheel assembly;
wherein the rear axle assembly is arranged on a first end of the frame; the wheel assembly comprises a support rod and a first wheel; a first end of the support rod is connected with the rear axle assembly, and a second end of the support rod is connected with the first wheel; and the support rod is configured to inclinedly extend from the first end of the support rod towards an outer side of the frame.

2. The tractor of claim 1, wherein the support rod comprises a first support section, a second support section and a third support section connected in sequence; the first support section is connected with the rear axle assembly; an extension direction of the first support section is parallel to a travel direction of the tractor; the second support section is arc-shaped; the third support section is configured to inclinedly extend from an end of the second support section away from the first support section towards the outer side of the frame; and the third support section is connected with the first wheel.

3. The tractor of claim 1, wherein the rear axle assembly comprises a rear axle housing; the tractor further comprises a mounting component; the mounting component is fixedly provided on the rear axle housing; the frame is connected with the mounting component; and the first end of the support rod is connected with the mounting component.

4. The tractor of claim 3, wherein the mounting component comprises two mounting plates; the two mounting plates are oppositely arranged on upper and lower sides of the rear axle housing, respectively; one of the two mounting plates is connected with the frame, and the other of the two mounting plates is connected with the support rod.

5. The tractor of claim 1, further comprising:
a front axle assembly;
wherein the front axle assembly comprises a connecting rod and a swing axle; the connecting rod is arranged on a second end of the frame; the swing axle is inserted through the connecting rod, and is rotatably connected with the connecting rod; and the swing axle is configured to swing up and down within the connecting rod.

6. The tractor of claim 5, further comprising:
two second wheels;
wherein the two second wheels are arranged on two ends of the swing axle, respectively.

7. The tractor of claim 1, further comprising:
two second wheels;
wherein the two second wheels are arranged on two ends of the rear axle assembly, respectively; and the two second wheels are rotatably connected with the rear axle assembly.

8. The tractor of claim 7, further comprising:
a driving component;
wherein the driving component is arranged on the rear axle assembly; the driving component is connected with the two second wheels; and the driving component is configured to drive the two second wheels to rotate relative to the frame, so as to drive the tractor to move.

9. The tractor of claim 8, further comprising:
a controller;
wherein the controller is arranged on the frame; and the controller is electrically connected with the driving component, and is configured to control the driving component to start or stop.

10. The tractor of claim 1, further comprising:
a ball joint assembly;
wherein the ball joint assembly is arranged on the frame; and the ball joint assembly is configured to connect with a cargo carrier.
